(19) United States
(12) Patent Application Publication
(10) Pub. No.: US 2016/0143299 A1
(43) Pub. Date: May 26, 2016

(54) Toasted Corn Flour in Corn-Based Snack Foods

(71) Applicant: Frito-Lay North America, Inc., Plano, TX (US)

(72) Inventor: Kevin C. COGAN, Oak Point, TX (US)

(21) Appl. No.: 14/551,859

(22) Filed: Nov. 24, 2014

(51) Int. Cl. A21D 8/02; A23L 1/00; A21D 13/00; A21D 2/18; A21D 6/00

(52) U.S. Cl. CPC A21D 8/02; A21D 2/186; A21D 6/003; A21D 13/0074; A23L 1/0008

(57) ABSTRACT

Exemplary embodiments provide methods of making a masa and exemplary corn-based snack food products made from the masa. The methods of making the masa include the steps of hydrating kernel corn; grinding the hydrated corn; and adding corn flour previously treated to deactivate enzymes therein to thereby make a masa comprised of hydrated ground corn and the added treated corn flour. Optionally, the treated corn flour may be corn flour that has been toasted to deactivate enzymes. The deactivation of the enzymes avoids an organoleptic property of a “raw” taste in the snack food product containing the corn flour.

### BACKGROUND

1. Field of the Technology

The technology relates to the field of mass produced snack foods, and more particularly to snack foods that are corn-based and include a proportion of toasted corn flour.

2. Description of the Related Art

There are currently a variety of corn-based snack foods available in the marketplace. These corn-based snacks include corn tortilla chips, corn chips, and multi-grain chips, which are corn-based but may include other grain, seed and/or nut additives. These corn-based snack foods may be derived from yellow, white or blue corn and provide a colorful variety. Further, these may be flavored with a variety of seasonings.

In general and in brief summary, the production of a corn-based snack food proceeds by first making a “masa,” which is a corn-based dough, from kernels of corn, under controlled conditions. The masa is then available for either sheeting, to make tortilla chips, or is extruded to make corn chips. For example, to make tortilla chips, the masa is sheeted, and the sheeted masa is cut into shapes (usually triangles or circles) for baking or toasting followed by frying in hot oil. The chips are seasoned, and then packaged.

During the milling of corn, several corn component products are obtained. The solid corn component products include in order of increasing fineness of granularity: grits, corn meal, and corn flour. However, corn meal is generally a higher value product than corn flour in the marketplace.

### SUMMARY

The following is a summary of some aspects and exemplary embodiments of the present technology, of which a more detailed explanation is provided under the Detailed Description section, here below.

An exemplary embodiment provides a method of making a masa. The method includes the steps of hydrating kernel corn; grinding the hydrated corn; and adding corn flour previously treated to deactivate enzymes therein to thereby make a masa comprised of hydrated ground corn and the added treated corn flour.

Optionally, the step of adding treated corn flour may include adding corn flour that has been toasted to deactivate enzymes. In an exemplary embodiment, the corn flour may be toasted at a temperature of from a minimum of about 90° C. to about 100° C. to deactivate enzymes. The corn may also be toasted to temperatures as high as 200° C. to about 230° C. without creating a burned or charred flavor while deactivating the enzymes.

In an exemplary embodiment the step of adding the treated corn flour may include adding, immediately following the step of grinding the hydrated corn.

In an exemplary embodiment, the step of adding treated corn flour may include adding from about 2 to about 25 wt. % treated corn flour, based on the total weight of the masa with the corn flour. In another exemplary embodiment, the step of adding treated corn flour may include adding from about 3 to about 20 wt. % treated corn flour, based on the total weight of the masa with the corn flour. In a yet further exemplary embodiment, the step of adding treated corn flour may include adding from about 5 to about 15 wt. % treated corn flour, based on the total weight of the masa with the corn flour.

An exemplary embodiment provides a method of making a corn-based snack food. The method includes the steps of hydrating kernel corn; grinding the hydrated corn; and adding corn flour treated to deactivate enzymes therein to thereby make a masa comprised of hydrated ground corn and the added treated corn flour. Further, the method includes the steps of shaping the masa; and cooking the shaped masa to produce the snack food.

Optionally, in the method of making the corn-based snack food, the step of adding treated corn flour may include adding corn flour that has been toasted to deactivate enzymes. In an exemplary embodiment, the corn flour may be toasted at a temperature of from a minimum of about 90° C. to about 100° C. to deactivate enzymes; and up to temperatures as high as 200° C. to about 230° C., without creating a burned or charred flavor while deactivating the enzymes.

In an exemplary embodiment of the method of making the corn-based snack food the step of adding the treated corn flour may follow the step of grinding the hydrated corn.

In an exemplary embodiment of the method of making the corn-based snack food, the step of adding treated corn flour may include adding from about 2 to about 25 wt. % treated corn flour, based on the total weight of the masa with the corn flour. In another exemplary embodiment of the method of making the corn-based snack food, the step of adding treated corn flour may include adding from about 3 to about 20 wt. % treated corn flour, based on the total weight of the masa with the corn flour. In a yet further exemplary embodiment of the method of making the corn-based snack food, the step of adding treated corn flour may include adding from about 5 to about 15 wt. % treated corn flour, based on the total weight of the masa with the corn flour.

Optionally, an exemplary corn-based snack food may be made by a method that includes the steps of hydrating kernel corn; grinding the hydrated corn; and adding corn flour that has been toasted to deactivate enzymes therein to thereby make a masa comprised of hydrated ground corn and the added toasted corn flour. Further, the method includes the steps of shaping the masa; and cooking the shaped masa.

### BRIEF DESCRIPTION OF THE DRAWINGS

The foregoing aspects and many of the attendant advantages of the present technology will become more readily appreciated by reference to the following Detailed Description, when taken in conjunction with the accompanying simplified drawings of exemplary embodiments. The illustrative, schematic drawings, briefly described here below, are not to scale, are presented for ease of explanation and do not limit the scope of the inventions recited in the accompanying patent claims.

FIG. 1 is a flow chart of steps in an exemplary method of making a snack food product that includes enzyme-deactivated corn flour.

FIG. 2 is a flow chart of steps in another exemplary method of making a snack food product that includes enzyme-deactivated corn flour.

### DETAILED DESCRIPTION

The following non-limiting detailed descriptions of examples of embodiments of the technology may refer to appended drawing Figures and are not limited to the drawings, which are merely presented for enhancing explanations of features of the technology. In addition, the detailed descriptions may refer to particular terms of art, some of which are defined herein, as appropriate and necessary for clarity.

In general, corn is processed into several products. Briefly, and by way of background, in some methods of corn processing, corn kernels are separated from the cob, and may be hydrated to about 10-15 wt. % moisture, if necessary. The kernels are processed to remove the tough outer coating (the pericarp) and to remove the corn germ. Next, the corn may be milled to produce corn products that can be separated by sizing. The medium sized corn granules are known as “grits” and these are used, for example, as brewery feedstock, and the manufacture of breakfast cereals. Smaller sized granules are known as “corn meal,” and these are used in making a variety of foods. The finest granules are known as “corn flour,” which is used for example as animal feed and as a feed stock for making ethanol biofuel. In general, corn flour is not a high value product from an economic standpoint, but may be regarded as a low value by-product that is an inevitable part of milling corn to produce grits and corn meal.

In the production of corn-based snack foods, corn kernels are typically processed to produce a masa of desired moisture content. The addition of corn flour, at some point in the processing of corn kernels, to “back out” or reduce the amount of corn kernels necessary to produce a mass of masa may be desirable from an economic standpoint because the price of corn kernels exceeds that of corn flour, on a mass basis. However, the substitution cannot be made because corn flour imparts an undesirable organoleptic property: it imparts a “raw taste” that is unacceptable to consumers.

It has now been found that corn flour can be treated to deactivate enzymes in the corn flour and to thereby eliminate the undesirable raw taste that occurs in snack foods that contain corn flour. In an exemplary method, the enzymes may be deactivated by toasting the corn flour prior to addition of the corn flour to the masa. The result may be regarded as surprising because in making a snack food product, especially corn tortilla chips, corn chips and corn-based multi-grain chips, the masa dough is fried at high temperature after having been suitably formed into a desired shape and toasted. Accordingly, one might have expected the enzyme heat-deactivation of any corn flour present in the masa to have taken place during baking or frying and that the raw taste would not occur. Unexpectedly, toasting the corn flour, or otherwise deactivating the enzymes prior to incorporation into the masa and before masa baking or frying, removes the undesirable and unacceptable raw taste. In accordance with an exemplary embodiment of the snack food product incorporating corn flour, the organoleptic property of a raw taste is not present.

In an exemplary embodiment, the corn flour may be toasted at a temperature of from a minimum of about 90° C. to about 100° C. to deactivate enzymes. The corn may also be toasted to temperatures as high as 200° C. to about 230° C., without creating a burned or charred flavor while deactivating the enzymes, while still eliminating the raw taste that would otherwise occur in snack food products that include corn flour. Thus, a temperature in the range from about 190° C. and up to about 230° C., is useful. Other methods of enzyme deactivation, such as chemical treatment or exposure to electromagnetic radiation, such as ultraviolet or infrared energy, may also be useful.

The favorable organoleptic property of maintaining a masa flavor while lacking a raw taste is maintained for a wide range of weight percent addition of the enzyme-deactivated corn flour to masa. In an exemplary embodiment, enzyme-deactivated corn flour may be added to masa to make up from about 2 to about 25 wt. % of the total mass of the masa and the added enzyme-deactivated corn flour. In another exemplary embodiment, enzyme-deactivated corn flour may be added to masa to make up from about 3 to about 20 wt. % of the total mass of the masa and the added enzyme-deactivated corn flour. In yet another exemplary embodiment, enzyme-deactivated corn flour may be added to masa to make up from about 5 to about 15 wt. % of the total mass of the masa and the added enzyme-deactivated corn flour. Moreover, in an exemplary embodiment, toasted corn flour may be added to masa to make up from about 2 to about 25 wt. % of the total mass of the masa and the added toasted corn flour. In another exemplary embodiment, toasted corn flour may be added to masa to make up from about 3 to about 20 wt. % of the total mass of the masa and the added toasted corn flour. In yet another exemplary embodiment, toasted corn flour may be added to masa to make up from about 5 to about 15 wt. % of the total mass of the masa and the added toasted corn flour.

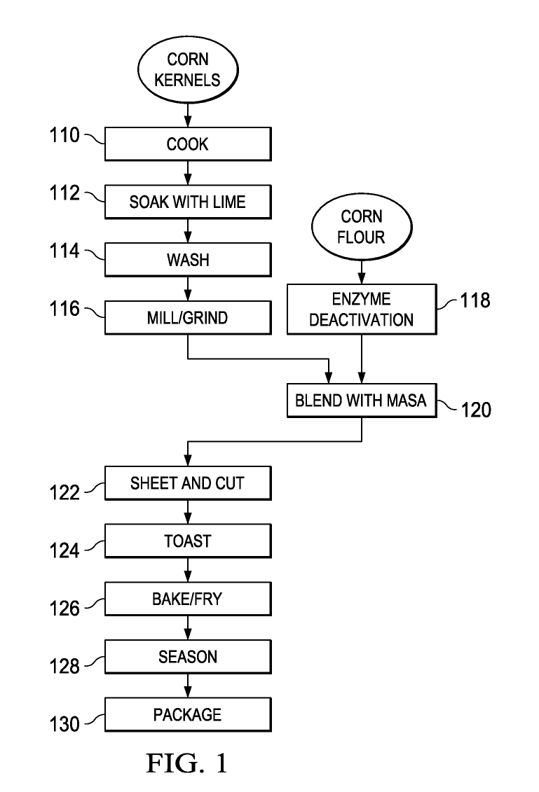

An exemplary embodiment of a method of making a masa that includes enzyme-deactivated corn flour, and that includes making a corn-based snack food, is depicted in the flow chart of the FIG. 1. The flow chart is not intended to be exhaustive, and additional steps clearly may be added for particular circumstances, but the illustrative flow chart generally indicates the point of addition of the enzyme-deactivated corn flour, in this embodiment shown as toasted corn flour.

In the example of FIG. 1, the process 100 includes a step 110 of heating the corn kernels in water up to 100° C. over a period of about 20 to about 30 minutes, and maintaining at about 100° C. for about 5 minutes to soften the pericarp for removal, but not so long as to cause gelatinization of the starch in the corn. The corn kernels are then cooled and soaked at about 50° C. for 8 to 12 hours to hydrate the corn kernels, in step 112. In step 114 the hydrated kernels (40 to 45 wt. % moisture) are washed in water, and the pericarp is removed. The pericarp-free corn kernels are then ground in step 116, typically in a stone mill. Deactivation of the enzymes of the corn flour in step 118 can be through toasting, or through chemical means, as long as the organoleptic taste property is modified to remove the raw taste. Thereafter, the ground masa exiting step 116 can be commingled with the enzyme-deactivated corn flour in step 120. The resulted mixture may be sheeted and cut, for example into triangular or circular shapes to make tortilla chips, in step 122. The shaped pieces of masa are toasted, typically to reduce moisture content to about 36 to 40 wt. %, in step 124. Thereafter, in step 126, the toasted chips are either baked or fried in hot oil (about 180° C.) to a moisture content of about 1.5-3 wt. %. The fried chips can then be seasoned in step 128. The seasoned chips are then packaged in step 130 to ultimately be sold to consumers.

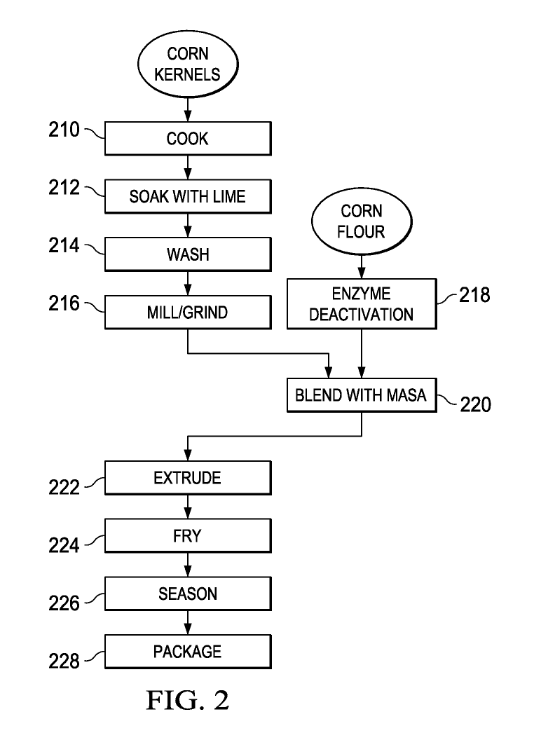

In another example, illustrated in FIG. 2, the process 200 includes a step 210 of heating the corn kernels in water up to 100° C. over a period of about 20 to about 30 minutes, and maintaining at about 100° C. for about 30 to 45 minutes to partially gelatinize the starch in the corn. The gelatinized corn is then sequentially soaked in step 212, washed, in step 214, and milled or ground in step 216. Prior deactivation of the enzymes of the corn flour in step 218 can be through toasting, or through chemical means, as long as the organoleptic taste property is modified to remove the raw taste. Thereafter, in step 220, the enzyme-deactivated corn flour of step 218 is commingled with masa exiting step 216. The mixture may be extruded, for example into shapes to make corn chips, in step 222. The shaped extruded pieces of masa are fried in hot oil (about 180° C.) to a moisture content of about 0.5-3 wt. %. The fried chips can then be seasoned in step 226 and packaged in step 226 to ultimately be sold to consumers.

While examples of embodiments of the technology have been presented and described in text and some examples also by way of illustration, it will be appreciated that various changes and modifications may be made in the described technology without departing from the scope of the inventions, which are set forth in, and only limited by, the scope of the appended patent claims, as properly interpreted and construed.

1. A method of making a masa, the method comprising:
hydrating kernel corn;
grinding the hydrated corn; and
adding corn flour treated to deactivate enzymes therein to thereby make a masa comprised of hydrated ground corn and the added treated corn flour.

2. The method of claim 1, wherein the step of adding treated corn flour comprises adding corn flour toasted to deactivate enzymes.

3. The method of claim 2, wherein the step of adding treated corn flour comprises adding corn flour toasted at a temperature of at least from about 90° C. to about 100° C. and up to about 200° C. to about 230° C. to deactivate enzymes.

4. The method of claim 1 wherein the step of adding the treated corn flour includes adding after the step of grinding the hydrated corn.

5. The method of claim 1, wherein the step of adding treated corn flour comprises adding from about 2 to about 25 wt. % treated corn flour, based on the total weight of the masa with the corn flour.

6. The method of claim 1, wherein the step of adding treated corn flour comprises adding from about 3 to about 20 wt. % treated corn flour, based on the total weight of the masa with the corn flour.

7. The method of claim 1, wherein the step of adding treated corn flour comprises adding from about 5 to about 15 wt. % treated corn flour, based on the total weight of the masa with the corn flour.

8. The method of claim 2 wherein the step of adding the treated corn flour includes adding after the step of grinding the hydrated corn.

9. The method of claim 2, wherein the step of adding treated corn flour comprises adding from about 2 to about 25 wt. % treated corn flour, based on the total weight of the masa with the corn flour.

10. The method of claim 2, wherein the step of adding treated corn flour comprises adding from about 3 to about 20 wt. % treated corn flour, based on the total weight of the masa with the corn flour.

11. The method of claim 2, wherein the step of adding treated corn flour comprises adding from about 5 to about 15 wt. % treated corn flour, based on the total weight of the masa with the corn flour.

12. A method of making a corn-based snack food, the method comprising:
hydrating kernel corn;
grinding the hydrated corn;
adding corn flour treated to deactivate enzymes therein to thereby make a masa comprised of hydrated ground corn and the added treated corn flour;
shaping the masa; and
cooking the shaped masa to produce the snack food.

13. The method of claim 12, wherein the step of adding treated corn flour comprises adding corn flour toasted to deactivate enzymes.

14. The method of claim 13, wherein the step of adding treated corn flour comprises adding corn flour toasted at a temperature of at least from about 90° C. to about 100° C. and up to about 200° C. to about 230° C. to deactivate enzymes

15. The method of claim 12, wherein the step of adding treated corn flour comprises adding from about 2 to about 25 wt. % treated corn flour, based on the total weight of the masa with the corn flour.

16. The method of claim 12, wherein the step of adding treated corn flour comprises adding from about 5 to about 15 wt. % treated corn flour, based on the total weight of the masa with the corn flour.

17. The method of claim 13, wherein the step of adding treated corn flour comprises adding from about 2 to about 25 wt. % treated corn flour, based on the total weight of the masa with the corn flour.

18. The method of claim 13, wherein the step of adding treated corn flour comprises adding from about 5 to about 15 wt. % treated corn flour, based on the total weight of the masa with the corn flour.

19. A corn-based snack food made according to claim 12.

20. A corn-based snack food made according to claim 13.
